(19) United States
(12) Patent Application Publication
(10) Pub. No.: US 2014/0263710 A1
(43) Pub. Date: Sep. 18, 2014

(54) Pressure Washer Pressure Valve Assembly

(71) Applicant: Generac Power Systems, Inc., Waukesha, WI (US)

(72) Inventors: Mir Khan, Kenosha, WI (US); Peter Nushart, Waukesha, WI (US)

(21) Appl. No.: 13/844,025

(22) Filed: Mar. 15, 2013

(51) Int. Cl. B05B 9/03

(52) U.S. Cl. CPC B05B 9/03
USPC 239/11; 137/1; 137/561 R; 239/526; 137/565.12

(57) ABSTRACT

A pressure washer unloader valve assembly having a movable operator that manipulates an orientation of a valve body to manipulate the flow pressure is communicated downstream of the valve assembly. A cam and follower interface is formed between the operator and the valve body such that the movable operator is movable within less than 360 radial degrees to effectuate manipulation the valve assembly between a fully open and a fully closed configuration. Preferably, the valve assembly is configured to achieve the fully open or fully closed orientations of the valve assembly during a single wrist rotation of a user during interaction with the movable operator either remotely or at a pump.

### FIELD OF THE INVENTION

The present invention relates generally to pressure washer systems, and in particular, to an adjustable valve assembly for generating a desired flow pressure downstream of the valve assembly.

### BACKGROUND OF THE INVENTION

Pressure washers generally include a motor or engine that is operatively connected to a water pump. A high pressure hose connects a wand to a discharge side of the water pump. The wand commonly includes a pistol grip or the like that includes a trigger whose actuation effects discharge of a high-pressure water stream from the nozzle. Both the simplicity of operation and effectiveness associated with using such devices has made pressure washers a staple for various residential and commercial cleaning and surface preparation tasks. Many cleaning and surface preparation operations can also include the use of extraneous cleaning or surface treatment agents. For instance, many deck and fence cleaning agents, automotive and/or fiberglass soaps, concrete cleaners, excreta, are commercially available and tailored to improve the efficiency of a particular cleaning operation. To effectuate a desired cleaning or surface preparation operation and increase the applicability of such devices, many pressure washers include a valve assembly associated with generating a desired variable pressure flow that can be configured for use with or without such soaps or agents.

The range of use of such pressure washers for various cleaning and surface preparation activities can also be increased by providing various alternate nozzle assemblies in addition to providing a flow pressure adjustment mechanism for adjusting the pressure of the flow stream that is delivered to the nozzle supported by the wand. Commonly, a pressure unloader valve assembly is provided between the output of the pump and a high pressure hose that is connected to the wand. The pressure unloader valve assembly commonly includes an operator or a handle that is rotatably connected to a housing and interacts with a valve body that is disposed in the housing. The valve body is commonly manually movable to selectively cooperate with a valve seat to define a bypass flow passage. Manipulation of the valve body relative to the valve seat alters a pressure of the fluid flow that is communicated to the wand by opening and closing the bypass fluid passage. FIG. 5 shows a schematic representation of a cross section view of one such pressure washer pressure unloader valve assembly.

Referring to FIG. 5, unloader valve assembly 10 includes a housing 12, a valve body 14, and an operator or handle 16 that is operably connected or engaged with valve body 14. Housing 12 defines an inlet flow passage 18, an outlet flow passage 20, and a bypass flow passage 22. Bypass flow passage 22 allows a portion of the fluid communicated through the valve assembly to equalize fluid flow pressure to mitigate undesired manipulation of the valve body relative to a valve seat 24 due to the working fluid flow pressure achieving a condition wherein the pressure of the fluid flow overcomes the bias of a spring 26 associated with the fluid flow control.

During normal operation, manual manipulation of handle 16 affects compression of spring 26 and bypass 22 allows a portion of the working fluid flow to enter a chamber 28 that is positioned nearer but fluidly isolated from spring 26 so that the fluid flow pressure does not achieve a condition wherein the fluid flow pressure associated with valve body 14 and seat 24 overcomes the desired bias of spring 26 resulting in undesired manipulation of valve body 14 relative to seat 24 and an undesired fluid flow through valve assembly 10.

Commonly, one of the handle 16 or valve body 14 threadably cooperates with housing 12 or are otherwise threadably cooperate with one another such that rotation of handle 16 effectuates only a corresponding longitudinal translation of valve body 14 relative to valve seat 24. The threaded cooperation 30, and the requisite longitudinal translation of the valve body 14 relative to the valve seat 24, is configured to provide a desired range and scale of the adjustment associated with manipulating the flow communicated to outlet 20. Commonly, handle 16 must be rotated more than 360 radial degrees to effectuate translation of the valve body 14 relative to the housing to achieve the closed and fully open configurations of the passage associated with manipulation of handle 16. Frequently, the user must repeatedly grip and turn handle 16 to achieve a desired adjustment of valve assembly 10 to generate a desired resultant operating flow pressure and flow stream. Some such valve assemblies also require axial displacement of the handle 16 to facilitate the rotational manipulation of the handle 16 and adjustment of the corresponding valve body 14. Repeated interaction with handle 16 is commonly required when it desired to manipulate the operating pressure from a relative maximum to a relative minimum flow condition associated with translating valve body 14 between a fully open position and a closed position relative to the corresponding valve seat 24.

Still another concern for such configurations is the integrity of the threaded interaction between the respective rotatable parts. The elongated threaded sections associated with the threadable interaction increases the potential for damage to the alternate threaded surfaces in as much as portions of one or more of the threaded surfaces may be exposed to conditions that degrade the operability of the threadable interaction. Degradation of the threaded interface can detract from the operability of the valve assembly such that greater user hand or grip strength is required to achieve the desired rotational manipulation of the handle relative to the valve assembly. If left unaddressed, such degradation can result ultimately in inoperability of the underlying valve assembly.

Even without such degradation of the threaded interface, providing a valve assembly wherein the orientation of the valve body relative to a corresponding valve seat is controlled by the pitch of the cooperating threadable interaction 30 limits the ratio associated with rotation of the handle for each wrist turn relative to a longitudinal translation of the valve body relative to the valve seat. User interaction or adjustment of the valve assembly can be time consuming and difficult or strenuous, particularly for those users with limited wrist motion, flexibility, or strength. Such considerations can be exacerbated for valve assemblies having degraded threadable interfaces.

Therefore, there is a need for a pressure washer flow pressure unloader valve assembly that is simple to operate and that provides a greater ratio of adjustment of a valve body relative to a valve seat relative to adjustment of a handle or operator than can be achieved with a threadably associated operator or handle, housing, and/or valve body.

### SUMMARY OF THE INVENTION

The present invention provides a pressure washer pressure unloader valve assembly that overcomes one or more of the drawbacks mentioned above. The pressure washer flow pressure unloader valve assembly according to one aspect of the invention includes a movable operator or handle whose manipulation alters an orientation of a valve body relative to a valve seat so as to manipulate an operating pressure that is communicated downstream of the valve assembly. The valve assembly includes a cam and follower interface that is formed between the handle and the valve body such that the movable operator rotates less than 360 radial degrees, and preferably within a range of rotation of a user's wrist, to effectuate manipulation the valve assembly between a fully open and a fully closed configuration during a single gripping of the operator.

Another aspect of the invention that is usable or combinable with one or more of the above features discloses a pressure washer pressure unloader valve assembly that includes a housing that defines an inlet and an outlet that are associated with a high pressure flow. A valve body is disposed in the housing and movable relative to the housing to define a variable shape passage between the inlet and the outlet. An operator is engaged with the valve body and configured to be manipulated by a user to alter a position of the valve body relative to the housing. A cam and follower interface is formed between the operator and the valve body and configured to allow translation of the valve body relative to the housing in response to movement of the operator to manipulate a spring pressure that regulates an output pressure associated with the high pressure flow.

Another aspect of the invention that is usable or combinable with one or more of the aspects above discloses a pressure washer that comprises a pump having an inlet that is configured to be connected to a water source and an outlet. A valve assembly is disposed between the outlet of the pump and a wand. The valve assembly comprises a housing manifold that defines a working fluid path that extends between the outlet of the pump and a wand and a bypass fluid path that is fluidly connectable to the working fluid path. The valve assembly includes a handle that is movable relative to the housing and a valve body that cooperates with the handle and is movable relative to the housing to define a fluid connection between the outlet of the pump and the wand. A cam and follower interface is formed between the handle and the valve body such that movement of the handle alters adjustment in the unloader valve assembly that changes a high pressure output.

Another aspect of the invention that is usable with one or more of the above aspects and features discloses a method of manipulating an output pressure of a pressure washer. The method includes providing a valve assembly that is configured to receive a pressurized flow from a pump and bifurcate the pressurized flow into a working flow stream and a bypass flow stream. A movable control is connected to the valve assembly and is movable between a first position and a second position that are within 180 radial degrees relative to one another to manipulate a valve between a fully open orientation and a closed orientation that regulates communication of the working flow upstream to an outlet of the valve assembly.

Other aspects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings illustrate the best mode presently contemplated of carrying out the invention.

In the drawings:

FIG. 1 is a perspective view of a portable engine powered pressure washing device having a pressure unloader valve assembly according to the present invention;

FIG. 2 is a perspective view of a pressure unloader valve assembly shown in FIG. 1;

FIG. 3 is a cross-section elevation view of the unloader valve assembly shown in FIG. 2 which the operator and valve body in a closed orientation;

FIG. 4 is transverse cross-section elevation view of the unloader valve assembly shown in FIG. 3; and

FIG. 5 is a view similar to FIGS. 3 and 4 of an exemplary prior art pressure unloader valve assembly.

### DETAILED DESCRIPTION OF THE DRAWINGS

FIG. 1 shows a portable engine powered pressure washer 40 equipped with a flow pressure unloader valve assembly 42, referred to hereinafter simply as a valve assembly, according to the present invention. As shown FIG. 1, pressure washer 40 includes an internal combustion engine 43 that is operationally connected to a pump 44. It is appreciated that one or more of the aspects disclosed herein may be applicable to pressure washer systems having other power sources, such as motor driven pumps, whereas other features or aspects of the proposed system may be applicable only to engine powered pressure washers, such as requiring a combustible fuel source and delivery system. Those skilled in the art will readily appreciate the alternative uses of various aspects disclosed herein.

Engine 43 can be directly or indirectly (via a power transmission system such as a belt or other flexible drive member) coupled to pump 44. When engine 43 directly cooperates with pump 44 without supplemental power transmission systems, pump 44 can be considered a direct drive pump. It is appreciated that there a number of methodologies associated with generating a desired fluid pressure output associated with operation and use of pressure washer 40. One methodology includes providing a pressure output of the pump that is a function of the operational revolutions per minute (rpm) of the pump and which is directly correlated to the operation speed or revolutions per minute (rpm) of the engine crankshaft. The higher the rpm of the pump, the higher the pump output pressure—assuming other system variables to be constant. In such a confirmation, the input rpm of the pump can be controlled by the engine rpm by means of controlling the engine throttle such that, variable pressures can be provided at the pump output pressure via manipulation of the engine throttle or engine speed. The variable pressure output in conjunction with an engine speed adjustment allows one pressure washer to act as though it were capable of providing several different fixed operating pressures. Alternatively, it is envisioned that engine 43 may be configured to operate at a desired engine speed such that the only manipulation of the output pressure communicated to a wand is attributable to adjustment or relative configuration of valve assembly 42.

As alluded to above, valve assembly 42 provides another methodology for manipulating the discharge pressure that is delivered to the wand that is usable with both pressure washers wherein the engine is capable of variable speed operation and a desired speed operation. Valve assembly 42 can be integrally formed with pump 44 or structurally independent but fluidly disposed between the output of the pump and a fluid inlet associated with a wand 46. A pressurized fluid flow is communicated from pump 44, through valve assembly 42, and therefrom to wand 46.

As explained further below, valve assembly 42 includes a control, regulator, or handle 86 whose position or orientation is associated with regulating the pressure flow communicated to the wand in a manner partially independent of engine operating speed. That is, valve assembly 42 allows the delivery of fluid to wand 46 at variable pressures that are at or below a maximum output pressure associated with the available water source pressure and given operating conditions of engine 43 and pump 44. Providing a pressure washer with an engine or motor capable of adjustable operation and adjustable valve assembly 42 increases the applicability of the pressure washer for various uses and the flow pressure signals that can be communicated to wand 46 between the relative minimum and maximum operating conditions of the motor, engine 43, or pump 44.

Still referring to FIG. 1, and as will be discussed further below with respect to the FIGS. 2-4, wand 46 is connected to a discharge or output side of valve assembly 42 via a hose 48. Wand 46 supports a trigger 50 that is located at one end of wand 46. A discharge nozzle 52 is disposed at an end of the wand 46 generally opposite trigger 50. Nozzle 52 may be adjustable and/or replaceable to provide a desired spray pattern during operation of pressure washer 40. Pressure washer 40 preferably includes a chassis 54 having one or more wheels 56 and a handle 60 for improving the mobility of the unit to facilitate convenient transportation of pressure washer 40.

Pressure washer 40 can include a panel, bezel, or dashboard 61 that can include one or more instructional indicia 64 associated with the desired operation or intended use of pressure washer 40. Preferably, dashboard 61 includes one or more indicia that explain, either textually or pictographically, proper operation of pressure washer 40. Preferably, dashboard 61 includes one or more receptacles or mounting portions 66 associated with supporting replaceable or interchangeable tips or nozzles 72, 74, 76, 78, 80 associated with the desired use of pressure washer 40. As is readily understood, nozzles 72-80 are configured to interchangeably cooperate with the discharge end of wand 46 so as to replace nozzle 52.

Alternatively, it is appreciated that nozzle 52 could be adjustable to provide more than one spray pattern. It is further appreciated that wand 46 may have integrated nozzles that are interchangeable and/or adjustable to allow various different functions including soaping via introduction of a detergent or other cleaning or treatment agent through an agent introduction system. As explained further below, valve assembly 42 is disposed in the fluid stream between pump 44 and wand 46 and is constructed to allow a user to manually manipulate the pressure of the fluid flow that is communicated to wand 46. Preferably, valve assembly 42 allows manipulation of the fluid flow pressure in a manner that does not generate unnecessary backpressure at locations that are fluidly upstream of the valve assembly 42.

FIG. 2 shows valve assembly 42 removed from pressure washer 40. Valve assembly 42 includes an operator or a handle 86 that is supported by a housing 88 of valve assembly 42. Handle 86 is movable relative to housing 88 so as define an operating pressure of the fluid flow communicated to a wand as disclosed above. Housing 88 defines an inlet 90 and an outlet 92 associated with communicating a working fluid between pump 44 and wand 46. That is, inlet 90 receives a pressurized fluid flow associated with operation of pump 44. It is appreciated that inlet 90 may alternatively define a source inlet associated with connecting valve assembly 42 of pressure washer 40 to a water source for those configuration wherein valve assembly 42 and pump 44 are provided in a unitary or singular construction, as is shown below with respect to FIG. 3. Regardless of the specific construction of valve assembly 42 relative to pump 44, valve assembly 42 is configured to receive a pressurized fluid flow associated with the operation of pump 44 on the working fluid. As used herein, the inlet associated with valve assembly 42 is defined as the portion of valve assembly 42 that receives the pressurized fluid flow attributable to operation of the pump 44 and the corresponding motor or engine.

Outlet 92 of valve assembly 42 is constructed to cooperate with high pressure hose 48 for communicating the pressurized fluid flow to a wand. As disclosed further below with respect to FIGS. 3 and 4, valve assembly 42 is configured to selectively fluidly connect the inlet 90 and outlet 92 via a relative position of the valve assembly. That is, operation of handle 86 allows for the selective open or closing of valve assembly 42. When valve assembly 42 is closed, working fluid flow is recirculated. As valve assembly 42 is opened via manipulation of handle 86, at least a portion of the fluid flow is communicated between inlet 90 and outlet 92 of valve assembly 42. When valve assembly 42 is adjusted, a maximum operating pressure associated with operation of pump 44 can be communicated through housing 88 and delivered to a wand connected to outlet 92.

As explained further below, user manipulation of handle 86 manipulates the degree of fluid connectivity associated with inlet 90 and outlet 92 thereby manipulating the pressure of the fluid flow that is communicated between inlet 90 and outlet 92. As explained further below, handle 86 is preferably rotatable less than 360 radial degrees to effectuate adjustment of the valve assembly 42 between the fully open or fully closed positioned. Preferably, handle 86 is rotatable no more than about 180 radial degrees to effectuate such operation. More preferably, handle 86 is rotatable about less than 365 radial degrees or a single user grip and wrist rotation to effectuate such adjustment of the fluid connectivity associated with bypass 102. It is appreciated that although specific degrees of radial rotation are disclosed, such radial rotation may deviate approximately 25 radial degrees from the exemplary relative radial distances disclosed. As mentioned above, in a preferred aspect of the invention, handle 86 can rotate a distance associated with a single wrist rotation of a user to effectuate opening and closing of valve assembly 42. It is appreciated that handle 86 may be replaced with remote manual or automatic actuators to effectuate the desired relative configuration of valve assembly 42 as is disclosed further below.

FIGS. 3 and 4 show alternate ordinate elevation cross-section views of valve assembly 42 along lines 3-3 and 4-4 shown in FIG. 2, respectively. Referring to FIGS. 3 and 4, housing 88 of valve assembly 42 defines a working fluid path or passage associated with a working fluid flow 100 that extends between inlet 90 and outlet 92 and communicates the pressurized fluid flow generated from the operation of pump 44. A bypass fluid path or passage 102 is defined by a portion of valve body 114 and communicates a portion of the working fluid flow to a chamber 116 associated with a biased manipulation of valve body 114 relative to a valve seat 122. A bypass fluid flow is fluidly connected to the pressurized fluid flow associated with flow 100 and is configured to provide a pressure equalization to chamber 116.

Handle 86 is supported by housing 88 and has a cam 108 connected thereto. Preferably, a keyed interface 110 is formed between handle 86 and cam 108 such that rotation of handle 86 effectuates rotation of cam 108 about an axis 112. Alternatively, it is appreciated that cam 108 can be integrally formed with handle 86. Regardless of the specific construction, cam 108 is configured to rotate relative to housing 88 via user manipulation of handle 86 or remote actuation of handle 86.

A valve body 114 of valve assembly 42 includes a first end 116 that is operationally associated with a plate 117 that slidably cooperates with an exterior or cam surface 118 of cam 108 and a second end 120 of valve body 114 is movable relative to a valve seat 122 associated with bypass 94. A spring 119 is disposed in chamber 116 and is operationally associated between plate 117 and valve body 114. Spring 119 is configured to bias valve body 114 or a bullet thereof into engage with a seat 122 associated with flow path 100. A cam interface 124 is defined by the cooperation of cam 108 associated with handle 86 and valve body 114 and/or plate 117 and spring 119. Spring 119, biases valve body 114 into contact engagement seat 122 and plate 117 into engagement with cam surface 118 of cam 108. It is appreciated that other biasing means, such as the introduction of a fluid pressure onto the contour of valve body 114, could effectuate the biasing of alternate biasing of valve body 114 into seat 122 and plate 114 into engagement with cam 108. It is further appreciated that valve body 114 could be biased into engagement with valve seat 122 and pulled away from the valve seat 122 via the slidable interaction with cam 108 associated with rotation of handle 86. That is, it is appreciated that various alternate biasing means and various alternate biasing directions may be utilized to effectuate a desired orientation of valve body 114 relative to valve seat 122.

In the orientation shown in FIGS. 3 and 4, it should be appreciated that valve 114 is in a fully closed orientation relative to seat 122 and maintained thereat via the bias of spring 119 and the relative orientation of cam 108. Manipulation of cam 108 in a rotational direction relative to plate 117 affects the bias force associated with spring 119 such that valve body 114 can dissociate from seat 122 to allow working fluid flow 102 to pass therebetween. Bypass 104 allows a portion of the working fluid flow to be communicated to chamber 116 to control the pressure that is communicated to outlet 92 of valve assembly 42. When valve assembly 42 is in a fully open orientation such that a portion of working fluid flow 100, that portion associated with bypass flow 102, is communicated to bypass 94 rather than being directed to outlet 92 of valve assembly 42 thereby lowering the operating pressure associated with the working fluid communicated to outlet 92 and therefrom to wand 46. Rotation of handle 86 effectuates rotational translation of cam 108 relative to plate 117 associated with of valve body 114 thereby effectuating longitudinal translation of valve body 114 relative to valve seat 122. Referring to FIGS. 3 and 4, rotation of handle 86 about axis 112 effectuates radial translation of cam surface 118 relative to end 116 of valve body 114 variable radial degrees, indicated by arrow 130, as a function of a relative degree of rotation of handle 86 relative to housing 88 of valve assembly 42.

Referring to FIG. 4, rotation of handle 86, preferably less than 360 radial degrees, effectuates longitudinal translation of valve body 114 relative the valve seat 122 such that valve body 114 can achieve a position wherein valve body 114 regulates bypass 102 from the working fluid passage associated with flow 100. Handle 86 can maintain various orientations between the position shown in FIG. 3 and FIG. 4 to effectuate changes in the size of a cross-sectional shape associated with the size of the opening of valve body 42. Such manipulation allows the user to incrementally manipulate the portion of fluid flow 100 that is allowed to exit valve assembly 42 via output 92 and in a manner that provides various pressure flow signals at outlet 92 that are then directed toward wand 46 and wherein the fluid pressure associated with chamber 116 can be manipulated to contribute to the positional association of valve body 114 relative to seat 122.

When valve body 114 is in engagement with valve seat 122 working fluid flow 100 is restricted from flowing through valve assembly 42 toward outlet 92 unless an over pressure condition exits such that a portion of the fluid flow can be directed to chamber 116. It should be appreciated that the orientation of valve body 114 relative to valve seat 122 shown in FIGS. 3 and 4 reflect a maximum working pressure associated with inlet 100 wherein valve assembly 42 maintains a closed orientation. Bypass 102 prevents the flow pressure associated with flow path 100 from manipulating the orientation of the valve assembly 42 relative to seat 122 Cam interface 124 allows the adjustment of the pressure flow communicated to outlet 92 relative to the flow signal associated with inlet 90 and allows the user to manipulate valve body 114 relative to valve seat 122 within a single gripping and wrist rotation interaction with handle 86 to manipulate the bypass flow in a manner that prevents the instantaneous flow pressure from manipulating the orientation of valve body 114.

Cam interface 124 allows the user to adjust the pressure flow signal that is communicated to output 92 from the available input pressure flow signal associated with input flow signal associated with inlet 90 between the relative minimum and maximum pressure flow signals in an expedient manner. Preferably, cam interface 124 allows translation of valve body 114 from the fully open and fully closed orientations relative to valve seat 122 with less than 360 radial degrees of rotation of handle 86. More preferably, the valve body is movable between the relative maximum and minimum positions with about 65 radial degrees of rotation of handle 86 and preferably within a range of a single wrist rotation achievable by most if not all user of pressure washer 40. Even if such manipulation cannot be achieved by a particular user, the positional association of the valve body relative to the radial position of the handle provides a valve assembly that allows more expedient adjustment of the bypass fluid flow than those associations wherein the adjustment of the valve body is thread pitch dependant.

Many changes and modifications could be made to the invention without departing from the spirit thereof. The scope of these changes will become apparent from the appended claims.

1. A pressure washer unloader valve assembly comprising:
a housing that defines an inlet and an outlet associated with a high pressure flow;
a valve body disposed in the housing and movable relative to the housing to define a variable shape passage between the inlet and the outlet;
an operator engaged with the valve body and configured to be manipulated by a user to alter a position of the valve body relative to the housing; and
a cam and follower interface between the operator and the valve body, the cam and follower interface configured to allow translation of the valve body relative to the housing in response to movement of the operator to manipulate a spring pressure that regulates an output pressure associated with the high pressure flow.

2. The pressure washer unloader valve assembly of claim 1 wherein the cam and follower interface is further defined as a cam surface that is associated with the operator and the follower is defined by at least one of a portion of the valve body or a mediator disposed between the cam and the valve body.

3. The pressure washer unloader valve assembly of claim 2 further comprising means for biasing the follower into engagement with the cam surface.

4. The pressure washer unloader valve assembly of claim 3 wherein the means for biasing is further defined as at least one of a spring or a fluid pressure.

5. The pressure washer unloader valve assembly of claim 1 wherein manipulation of the operator equal to or less than 360 radial degrees relative to the housing effectuates movement of the valve body from a first position wherein the variable shape bypass passage is fully closed to a second position associated with the bypass passage being fully open.

6. The pressure washer unloader valve assembly of claim 1 wherein the outlet flow path is downstream of the valve body and is constructed to be fluidly connected to a wand.

7. The pressure washer unloader valve assembly of claim 1 wherein the bypass flow path is fluidly connected to at least one of atmosphere and a low pressure side of a pump whose discharge is fluidly connected to a pump inlet flow.

8. A pressure washer comprising:
a pump having an inlet that is configured to be connected to a water source and an outlet; and
a valve assembly disposed between the outlet of the pump and a wand, the valve assembly comprising:
a housing manifold that defines a working fluid path that extends between the outlet of the pump and a wand and a bypass fluid path that is fluidly connectable to the working fluid path;
a handle that is movable relative to the housing;
a valve body that cooperates with the handle and is movable relative to the housing to define a fluid connection between the outlet of the pump and the wand; and
a cam and follower interface formed between the handle and the valve body such that movement of the handle alters adjustments in the unloader valve assembly that changes a high pressure output.

9. The pressure washer of claim 8 wherein the cam and follower interface is further defined as a cam surface formed by the handle or a remotely managed assembly and a follower defined as a portion of the valve body or mediator disposed between the cam and the valve body.

10. The pressure washer of claim 9 wherein the follower is connected by a spring to an end of the valve body.

11. The pressure washer of claim 8 further comprising a wand that is connected by a hose to an outlet of the housing associated with the working fluid path.

12. The pressure washer of claim 11 wherein the wand further comprises a trigger.

13. The pressure washer of claim 12 further comprising a nozzle attached to the wand and downstream of the trigger.

14. The pressure washer of claim 8 wherein the cam and follower interface facilitates translation of the valve body between a first position wherein the fluid connection is closed and a second position wherein the fluid connection is fully open in response to rotation of the handle from a first orientation to a second orientation wherein the first and second orientations of the handle are within 360 radial degrees from one another.

15. The pressure washer of claim 14 wherein the first and second orientations of the handle relative to the housing are within about 360 radial degrees from one another.

16. A method of manipulating an output pressure of a pressure washer, the method comprising:
providing a valve assembly that is configured to receive a pressurized flow from a pump and bifurcate the pressurized flow into a working flow stream and a bypass flow stream; and
connecting a movable control to the valve assembly, the movable control being movable between a first position and a second position that are within 180 radial degrees relative to one another to manipulate a valve between a fully open orientation and a closed orientation that regulates communication of working flow stream to an outlet valve assembly.

17. The method of claim 16 further comprising forming a cam surface on the movable control and positioning the cam surface to interact with a valve body associated with opening and closing the valve assembly.

18. The method of claim 16 wherein the first position and the second position of the movable control are within about 360 radial degrees of one another.

19. The method of claim 16 further comprising connecting a pump to the valve assembly and connecting a power source to the pump to drive the pump during operation of the power source.

20. The method of claim 16 further comprising providing a wand that is in fluid communication with the working flow stream of the valve assembly and providing a trigger that is supported by the wand to allow selective communication of the working flow stream to a nozzle.
